(19) United States
(12) Patent Application Publication
(10) Pub. No.: US 2010/0182712 A1
(43) Pub. Date: Jul. 22, 2010

(54) Spectrally Controlled Illuminator and Method of Use Thereof

(76) Inventor: Randal B. Chinnock, Southbridge, MA (US)

Correspondence Address: MIRICK, O'CONNELL, DEMALLIE & LOUGEE, LLP, 1700 WEST PARK DRIVE, WESTBOROUGH, MA, 01581, US

(21) Appl. No.: 11/772,363

(22) Filed: Jul. 2, 2007

(51) Int. Cl. G02B 5/22

(52) U.S. Cl. 359/890

(57) ABSTRACT

An optical spectrum equalizer and method, for modifying the output of a source of optical radiation. One or more optical filters are arranged in series in the path of the source. At least one filter defines a spatially-varying filter function. The position of at least one filter relative to the source is adjusted so that the filters together, as a whole, equalize the source spectrum by reducing the relative power of the source output at one or more of its wavelengths.

### FIELD OF THE INVENTION

This invention generally relates to the field of optical illuminators, particularly to wide-band optical illuminators that use light sources with non-uniform spectra, such as xenon or mercury arc sources.

### BACKGROUND OF THE INVENTION

Many optical measurement or test apparatuses operate by illuminating a test object with light from a source of known properties and measuring/observing the response of the test object in terms of reflection, absorption, scattering, or other means. A common procedure for making a measurement with such an apparatus includes the measurement of source properties—often the optical power spectrum—to be used as a calibration. This calibration is particularly important for certain classes of sources, such as arc lamp sources, for which the optical power spectrum can vary with time, temperature, lamp age, operating voltage, and other parameters that affect the source's spectral output. For critical measurements, this type of calibration is often applied to all classes of sources, including metal halide, tungsten, halogen, and fluorescent lamps, and LEDs. In spite of the ability to calibrate the source, in some applications it is desirable to shape the spectrum of the source to better match the measurements being made or the capabilities of the instrument or the inherent response of the test object. For example, it is often desirable to equalize the optical power spectrum of the source to eliminate the large spikes of power that normally are present at a few specific wavelengths. These large spikes tend to swamp the response of a detector system relative to the response at the lower power, adjacent wavelengths.

Even for systems with a light source having a generally smooth optical power spectrum, there are reasons to shape the source spectrum. For example, generally, neither the detector responsivity nor the spectral response of the test object is uniform across the entire measurement spectrum. In many applications the information to be measured is uniformly distributed across the optical spectrum. In such cases it is desirable to make the end-to-end system signal response uniform. A uniform end-to-end response provides an equal signal-to-noise response at all measurement wavelengths.

### SUMMARY OF THE INVENTION

The invention balances the source spectrum in order to optimize system response or signal to noise ratio across the measurement spectrum.

The present invention relates to an apparatus for providing illumination on an object with a smoothed or shaped wavelength spectrum. Generally, the apparatus comprises a light source or is attached to an existing light source. The source emits light in a relatively wide wavelength spectral band, e.g., it is a thermal or arc source. The spectrum of the source is known a priori and typically does not have uniform optical power at all wavelengths.

Light from the source is directed through one or more optical filters. The optical transmission of each filter has been designed such that the combined effect of the filters is to produce an illumination beam that has a pre-determined optical spectrum, said spectrum calculated to be better matched to the illumination task at hand than the inherent spectrum of the source. The set of filters in the apparatus are, generally, a subset of a larger group of available filters.

Generally, each filter is physically larger than the beam of light, allowing the filter to be moved inside the apparatus to position different sections of the filter in the beam. Additionally, each filter may have spatially varying optical properties so its effect on the beam varies with its relative position in the beam.

In some applications the source is “spiky”; that is, it has a number of well-defined, high power peaks in its optical spectrum. In this application, one or more filters are used to remove power from the beam at these peak spectral locations.

In other applications the light is used to illuminate an object that has a non-uniform spectral response or is sensed by a detector with non-uniform spectral response. In these applications, filters are selected to compensate for the non-uniform response.

In some embodiments the filters are area-modulated; that is, they comprise regions in which the filter function is operative (that is, the filter changes the spectrum of light passing through it) and regions in which no filter function is operative and the areal ratio of operative to non-operative filter regions varies (generally smoothly) across the filter substrate. In other embodiments the filter function itself varies across the filter substrate.

As used in this patent application, the following terms have the following meanings:
1) Filter—An object that is placed into the source radiation in order to modify the radiation.
2) Filter coating—the layers of material that affect the spectrum or intensity of the light passing through them.
3) Substrate—the transparent material on which the filter coating is deposited.
4) Filter function—the transmission of the filter coating (as deposited on the substrate) as a function of wavelength. 0 minimum, 1 maximum.
5) Area Weighted Transmission (AWT)—the ratio of input power to output power, as a function of wavelength for a particular size beam. The AWT can be a function of spatial location (x,y) on the substrate.

This invention features an optical spectrum equalizer, and a method, for modifying the output of a source of optical radiation that has a relatively wide wavelength spectral band with a predetermined distribution of power at different wavelengths within the band. The optical spectrum equalizer has one or more optical filters arranged in series in the path of the source beam. At least one filter defines a spatially-varying AWT. The filters together, as a whole, equalize the source spectrum by reducing the relative power of the output at one or more of the spectral band wavelengths. The filters may be transmissive or reflective.

The source may have one or more power spikes, and the filters may reduce the power of one or more of the spikes to be closer to the power at other wavelengths, to smooth the spectrum. The AWT of a filter may vary from a low in one portion of the filter to a high in another portion of the filter. A filter may define a notch function. At least one of the filters may have a filter coating applied to only portions of its face that is exposed to the source. The area weighted transmission of the filters may be varied by physically moving at least one filter relative to the source beam, either manually such as by using an adjustment mechanism that preferably has filter position calibration markings, or automatically. All of the filters are preferably adapted to be moved relative to the source.

The filter coating of at least one of the filters may essentially cover a first contiguous portion of the face, and the face may be essentially uncovered at a different second contiguous portion of the face. The amount of coverage within an area the size of the source beam may vary essentially continuously from the first portion to the second portion. The first contiguous portion may define a generally linear ramp shape. The first contiguous portion may define generally triangular areas. The coating may define a pattern of small contiguous areas separated by uncoated areas to define a pattern in which the areal density of the coating varies. The filter may essentially uniformly attenuate each part of the source beam.

A plurality of the filters may have a variable area coverage of the filter coating, and be movable relative to the source beam. At least a first filter may have a generally circular face. A first contiguous area of the circular face of the first filter may be covered with the filter coating. The first filter may be rotatable about an axis that is generally parallel to the source transmission axis and generally orthogonal to the covered face of the filter. The first filter may be partially covered with filter coating such that as the filter is rotated the AWT varies.

The filter may be a rugate notch filter. The filter may define a plurality of notches centered at different wavelengths.

The invention may further comprise a source of optical radiation that has a relatively wide wavelength spectral band with a predetermined, uneven distribution of power at different wavelengths within the band such that the power at one or more wavelengths is greater than the power at some of the other wavelengths, to accomplish a spectrally controlled illuminator.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

The foregoing and other objects, features and advantages of the invention will become apparent from the following description in conjunction with the accompanying drawings, in which common reference numbers refer to the same parts throughout the different views. The drawings are not necessarily to scale; emphasis has instead been placed upon illustrating the principles of the invention. Of the drawings:

FIG. 1 is a schematic diagram of an embodiment of a spectrally controlled illuminator of the invention;

FIG. 2A is a typical wavelength spectrum for a Xenon arc lamp of the type that can be used with the invention;

FIG. 2B is a typical wavelength spectrum for a Mercury-Xenon arc lamp of the type that can be used with the invention;

FIG. 3 is a schematic diagram of an embodiment of an illuminator of the invention as it is used in a typical application;

FIG. 4A is a partially broken-away drawing of an exemplary filter bank for an embodiment of the invention;

FIG. 4B illustrates a filter position adjustment approach for the filter bank of FIG. 4A;

FIGS. 5A, 5B and 5C illustrate three embodiments of an area modulated filter useful in the invention;

FIG. 6 illustrates the filter function for an embodiment of a linear variable edge filter useful in the invention;

FIG. 7 shows the filter function of a rugate optical filter designed to suppress four spectral components, useful in the invention;

FIG. 8 illustrates an angularly varying filter useful in the invention;

FIG. 9A illustrates the spectrum of a “spiky” source, useful in understanding the invention;

FIGS. 9B and 9C illustrate the filter functions of two notch filters that can be used to smooth the source shown in FIG. 9A in accordance with the invention;

FIGS. 9D-9G illustrates the source of FIG. 9A smoothed in several different manners by the combination of the filters having the filter functions shown in FIGS. 9B and C;

FIG. 10 illustrates a smoothed version of the source of FIG. 9A, as well as that smoothed source operated at twice the normal power;

FIGS. 11A and 11B are an example of the changes in a source as it ages, and an example of the aged source smoothed according to the invention, respectively;

FIG. 12 schematically depicts the face of a filter with a two-dimensional filter function for use in the invention; and

FIG. 13 is a schematic diagram of a feedback-based filter positioning control system for the invention.

### DETAILED DESCRIPTION OF THE INVENTION

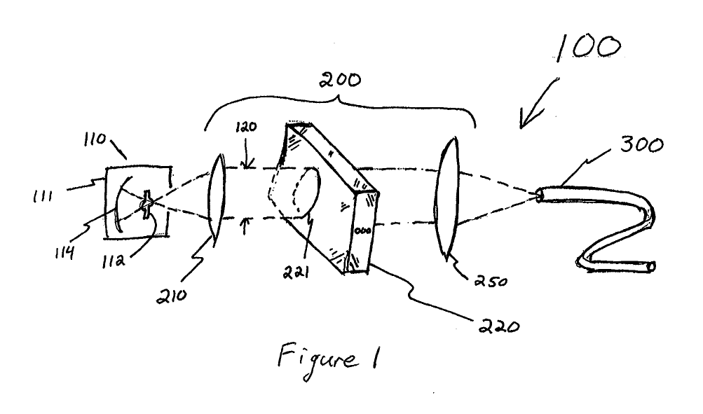

Referring to FIG. 1, an embodiment of the invention is an optical illuminator 100, which is typically used in optical experiments or in the measurement of the optical properties of a test object. Illuminator 100 comprises a source 110 of light and a bank 220 of optical filters. Filter bank 220 modifies the wavelength spectrum of source 110. Typically illuminator 100 also comprises beam forming optical elements 210 and 250 that match the beam parameters required inside filter bank 220 to the source 110 and to an output port, typically an optical fiber 300. For example, in the figure, element 210 is illustrated as converting an expanding cone of light into a generally collimated beam with beam size 120. The beam forming elements 210, 250 and the filter bank 220 form an optical spectrum equalizer 200.

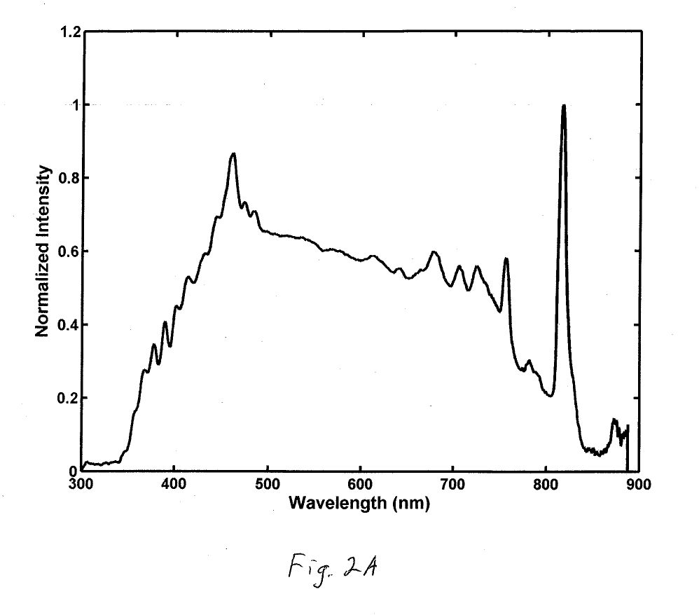

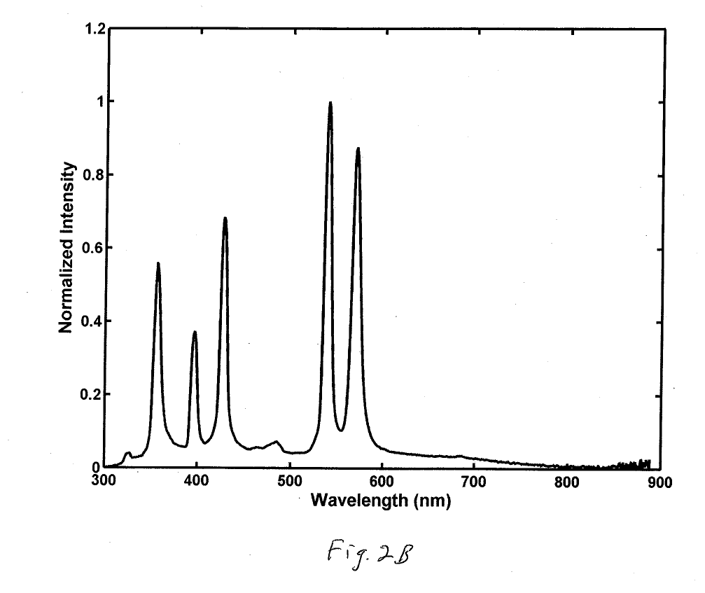

Source 110 is selected to match the wavelength, power, temporal response and other specifications of the measurement or test instrument in which the illuminator is to be used. Generally, source 110 has a broad optical spectrum. In one preferred embodiment, source 110 is an arc lamp comprising a housing 111, a collector or refocusing reflector 114, and the arc lamp bulb 112. Often the arc lamp bulb 112 is a xenon or mercury-xenon bulb. A typical wavelength spectrum for a Xe arc source is shown in FIG. 2A. As is clear from the figure, optical power from these arc sources is not uniformly distributed at all wavelengths in the operating band. More important to many applications, there are power spikes in the spectrum at specific wavelengths. These spikes are more prominent in the spectrum of the Hg—Xe arc bulb, as shown in FIG. 2B.

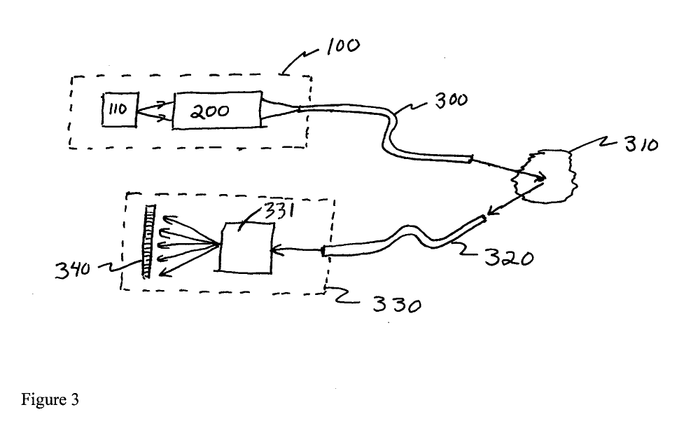

Optical spectrum equalizer 200 is designed to equalize, or smooth, the spectrum of source 110 to make the source more suitable for a predetermined operational use. For example, as shown in FIG. 3, illuminator 100 irradiates a tissue sample 310 disposed near the output end of fiber 300. Light scattered from tissue sample 310 is collected by a second optical fiber, collection fiber 320, whereby it is communicated into a spectrometer 330. Inside the spectrometer, the light is spectrally dispersed into a plurality of contiguous wavelength bands by a dispersive element 331, typically a grating or prism, and sensed by an array 340 of light sensitive elements such as photodiodes. Typically, array 340 has one photodiode for each band being sensed. In some applications it is desirable that there be a substantially equally strong signal generated by each light-sensing element of array 340. To achieve this equalization, the optical power in each wavelength band must be adjusted to account for 1) the power emitted by the source, 2) the general scattering properties of the tissue sample, 3) the wavelength responsivity of the photodiodes, and 4) any other system component that affects the measured spectrum, e.g., the optical fibers.

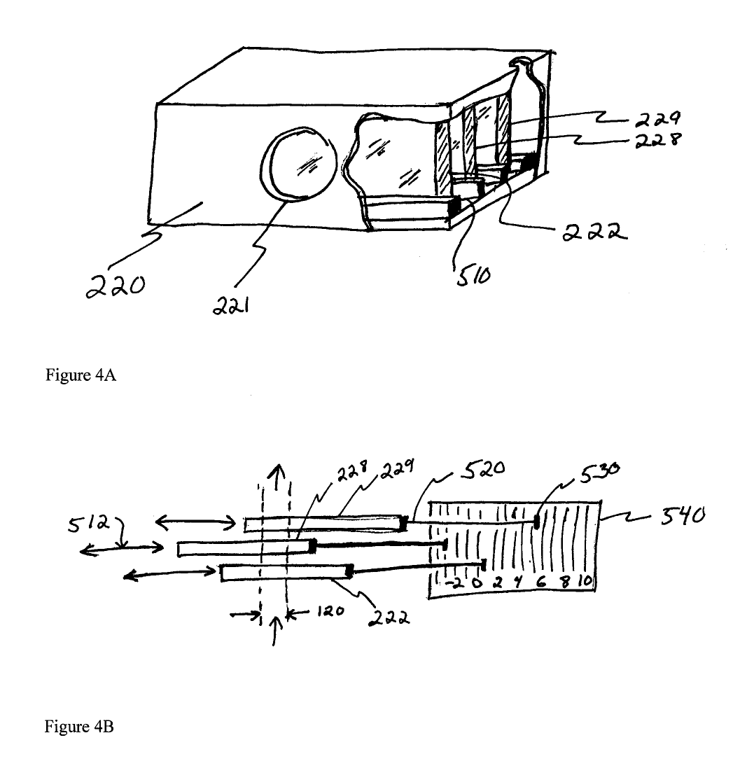

Equalization is effected in optical spectrum equalizer 200. See FIG. 4A. The broadband, unequalized light enters filter bank 220 through aperture 221, whereby it is directed through a series of one or more optical filters disposed in series in filter bank 220. For example, three filters 222, 228, 229 are illustrated in FIGS. 4A and 4B. Preferably, each filter has a different filter function (e.g., transmission as a function of wavelength) and the various filters are selected from an available assortment of filters such that, in combination, they reduce the higher powered spectral components relative to the rest of the spectrum, i.e., they equalize the spectrum.

Each filter is intentionally made larger than the beam size 120, which allows the user manually (or the system automatically) to move the filter to different relative positions in the source beam. This allows adjustment of the Area Weighted Transmission (AWT) accomplished by each filter. Each filter is disposed in mechanical connection to a filter position adjustment mechanism 510. For example, for rectangular plate shaped filters with a filter function that varies in one dimension, a simple guide rail/slide mechanism as illustrated in FIGS. 4A and 4B is sufficient. As shown in FIG. 4B, each adjustment mechanism 510 preferably includes a handle, adjusting lead screw, or similar element 520 with end-defining portion 530, to facilitate adjusting the filter relative to the beam. For example, handle 520 is grasped by the user to position the filter in the beam, causing the beam to pass through an at least partially different section of the filter. Furthermore, each filter is preferably individually adjustable, as indicated by arrows 512. Preferably, each adjustment mechanism is provided with a scale 540 or position calibration markings to allow the filter to be positioned deterministically, in accordance with a predetermined setting.

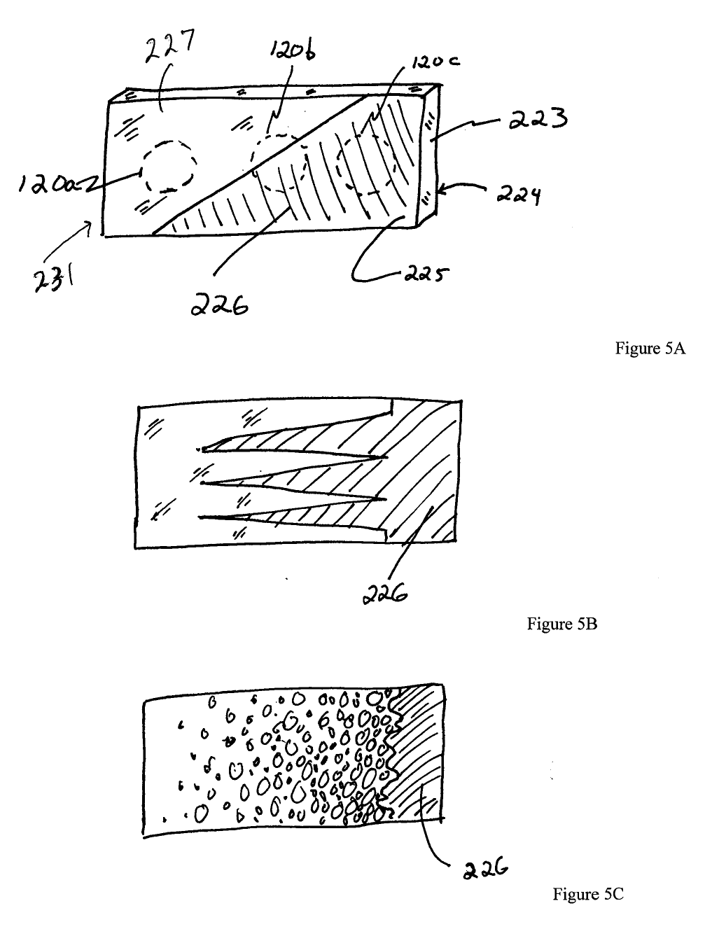

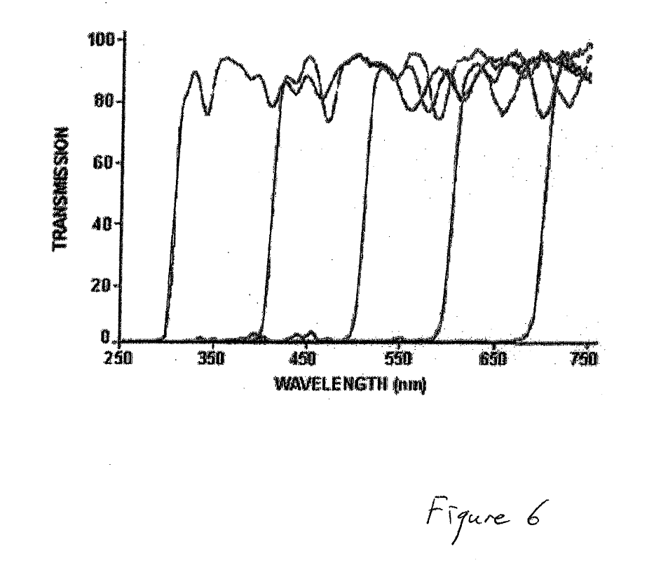

An example of a typical filter 231 for the optical spectrum equalizer 200 is illustrated in FIG. 5A. As is well known, a filter comprises a (typically rectangular prism shaped) substrate 223 with a first face 225 and a second face 224. Substrate 223 is typically an optical material selected to be highly transparent in the wavelength band of interest, for example a glass, or quartz. An optical filter coating 226 is disposed on first face 225 while, preferably, a broadband anti-reflection coating is disposed on second face 224. In some applications, filter coating 226 is only disposed on portions of first face 225, in which applications a broadband anti-reflection coating is preferably disposed on the portions 227 of first face 225 which do not have filter coating 226 thereon, e.g., the anti-reflection coating is deposited in the gaps between filter coating 226. For scale reference, a typical beam size 120 is also illustrated as a beam footprint in the figure. Although not preferred, reflective rather than transmissive filters can be used.

As shown as an example in FIG. 5A, the optical filter coating is preferably selectively deposited on portions of first face 225. This spatially selective deposition is typically effected using lithographic or other masking techniques. The spatial pattern is generally designed to vary the fraction of the beam affected by the filter coating as the filter position is adjusted. In one embodiment, the linear ramp illustrated in FIG. 5A will substantially change the fraction of the beam size 120 covered by the filter coating from a minimum to a maximum as the filter is translated. As an example, FIG. 5A illustrates three beam footprints 120a, 120b, and 120c in positions corresponding to minimum, partial, and maximum AWT.

Of course, there are many other spatial patterns which provide substantially the same effect. FIG. 5B illustrates a second embodiment in which the coating has been deposited in several parallel triangular areas to provide a similar variable areal coverage of a beam of size 120.

FIG. 5C illustrates a third example of a spatially varying pattern in which the filter coating may be deposited to achieve an end-to-end coating coverage variation. In this example, the coating is deposited in a pattern of dots or other small contiguous areas separated by uncoated areas, in which the spatial density increases from one end of the filter to the other, from fully covered to fully uncovered. As with the filter patterns of FIGS. 5A and 5B, the AWT in a beam-sized region of the filter varies from a minimum to a maximum as the slide is translated. This embodiment has the advantage of more uniformly attenuating each part of the beam as the filter is translated. This may be important where the spectral content of the beam has a spatial dependence, or where the output of the beam is not coupled into a spatial integrator such as an optical fiber, e.g., an imaging application.

Other spatial variations in the filter function can also be used. For example, as shown in FIG. 6, it is possible to fabricate a filter in which the filter's behavior varies spatially from one end to the other. The basic filter function in this example is a sharp cutoff edge filter. The cutoff wavelength varies with position along the filter substrate. Each trace in the figure illustrates the filter function at a selected point along the filter.

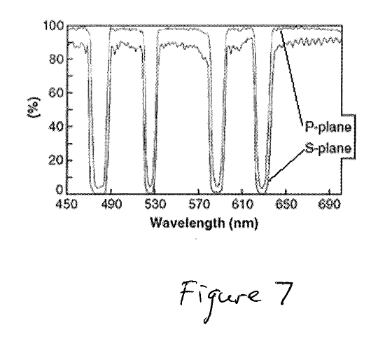

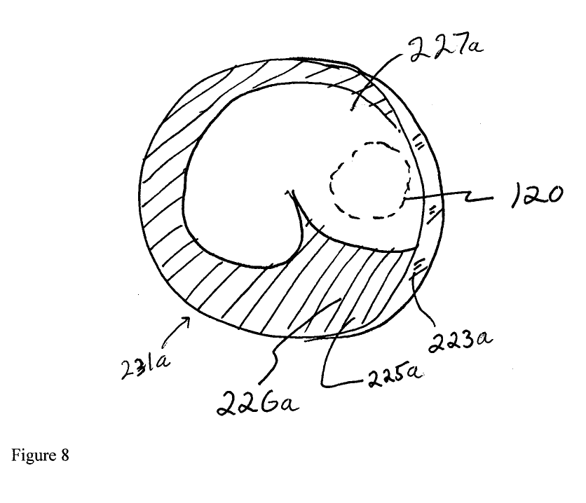

In certain embodiments the filters may be multi-layer dielectric (MLD) filters, which are well known in the art. In a standard MLD filter each layer of the filter coating has a uniform index of refraction and the filter is built up by alternating layers of different indices of refraction and thickness. In some embodiments of the invention, a rugate filter may be used. A rugate filter is one in which the discrete layers of an MLD filter are replaced by a single layer in which the index of refraction varies continuously with depth. Rugate notch filters have very high transmission in wavelength regions outside the notch while eliminating higher order reflection bands and can be designed to cleanly suppress several lines simultaneously, as shown in FIG. 7.

The filter coating can accomplish a desired filter function, as described herein. In one embodiment, a filter function of 0 can be accomplished with a coating that is opaque. Variable coverage with an opaque material allows the user to adjust the intensity of the source output without affecting the spectrum of the source. This feature could be useful to make up for source power variations; for example, if the voltage or current increased for any reason, the increased beam intensity could be attenuated with such a variable, zero filter function filter.

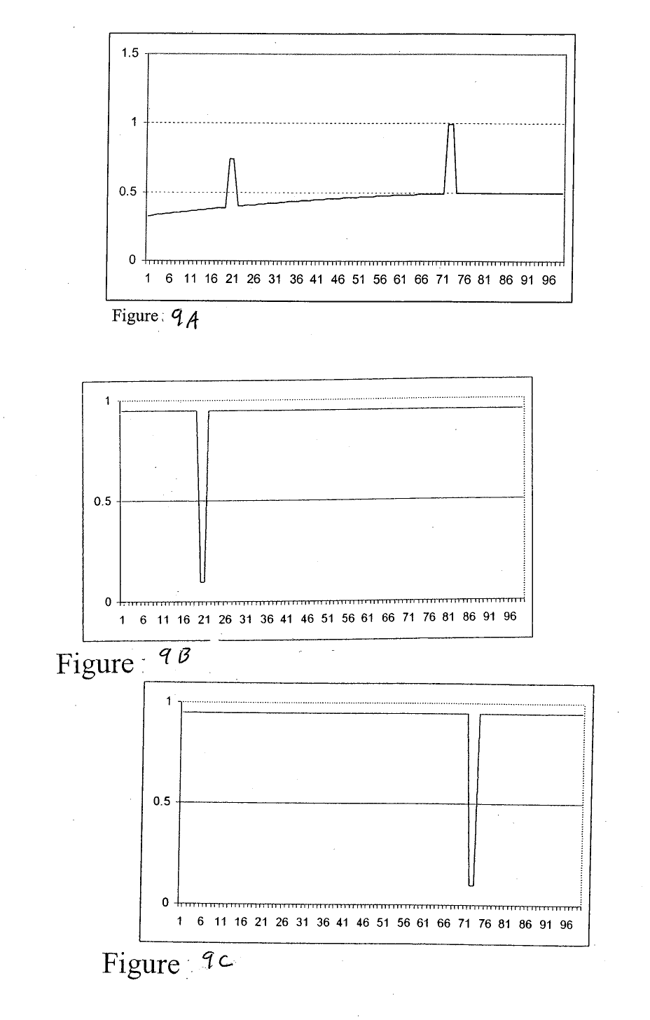

The filter bank 220 illustrated in FIG. 1 uses rectangular filters which vary in their filter function from one end to the other. The filters are positioned by linearly translating them relative to the beam. In other embodiments, the filter bank can contain multiple disk-shaped filters, wherein the AWT varies spatially with angle around the disk and where the positioning mechanism is designed to rotate the filter about an axis generally perpendicular to its surface. FIG. 8 illustrates one embodiment of a spatial filter coating pattern for an angularly varying filter 231a comprising substrate 223a that includes filter coating 226a and uncoated area 227a on face 225a, along with uncoated region 227a. Beam 120 is shown to illustrate the variable AWT accomplished with this filter.

In operation, the inventive optical spectrum equalizer is used to control non-uniformities in the spectral performance of an instrument. The non-uniformities have multiple roots, including the source, the test object, the detector, and other elements in the optical path. Since there are several possible choices for each of these three variables, it is impractical to acquire unique filters for each possible combination. Even if it were possible to do so, having this set of separate filters for each combination would preclude making changes in the net filter function as the components age. In the present invention, the filters in the filter bank can be mixed and matched to meet the particular instrument setup from a relatively small set of available filters.

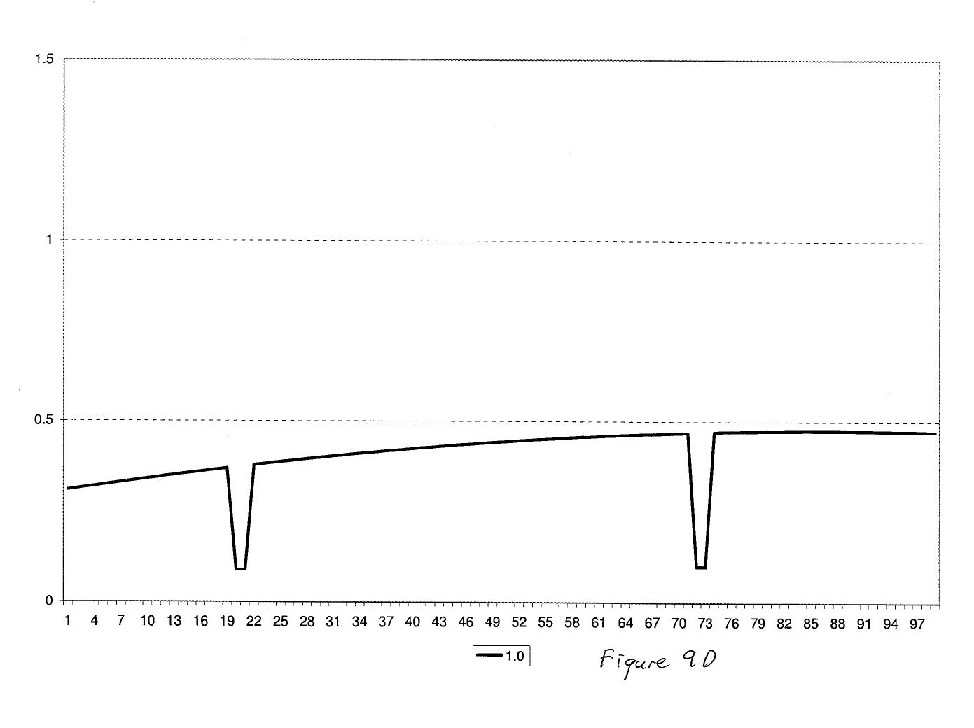

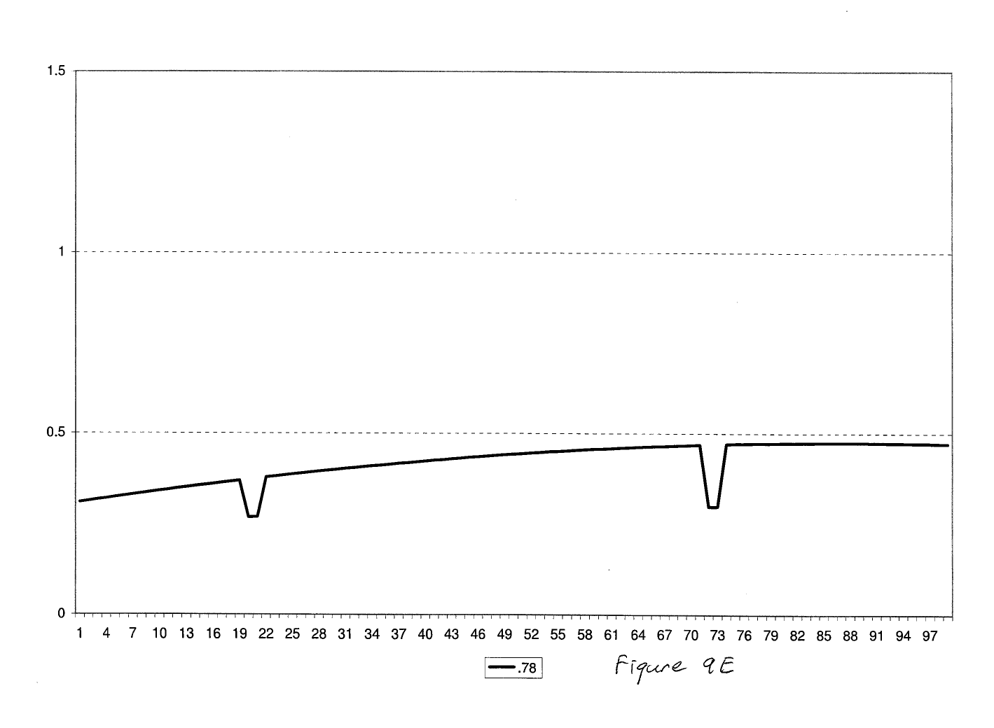

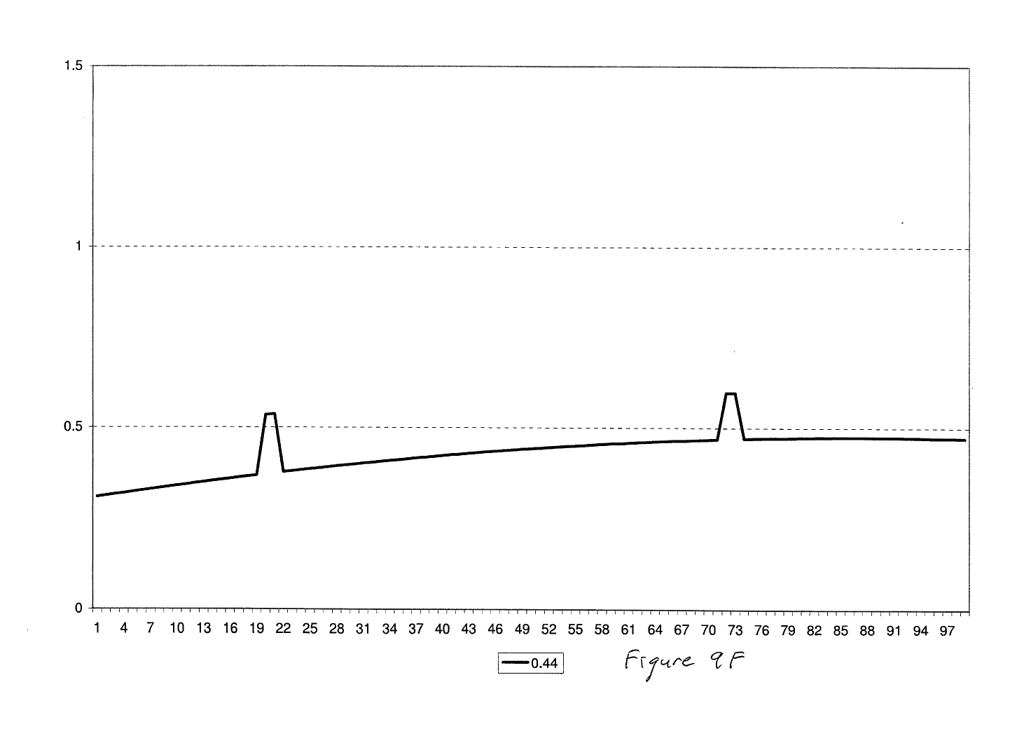

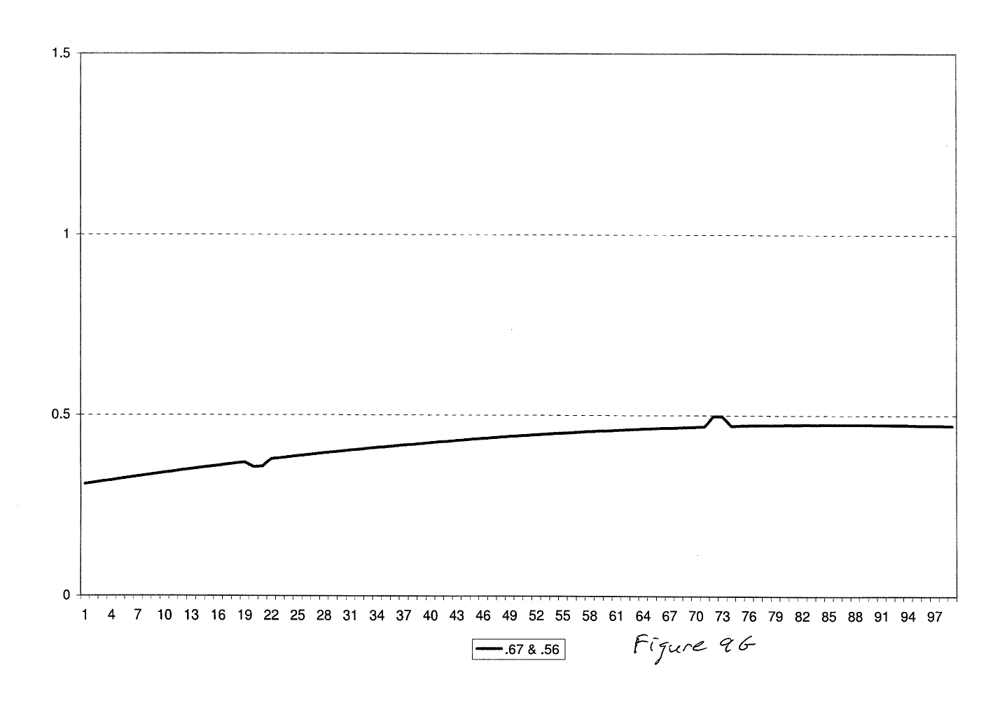

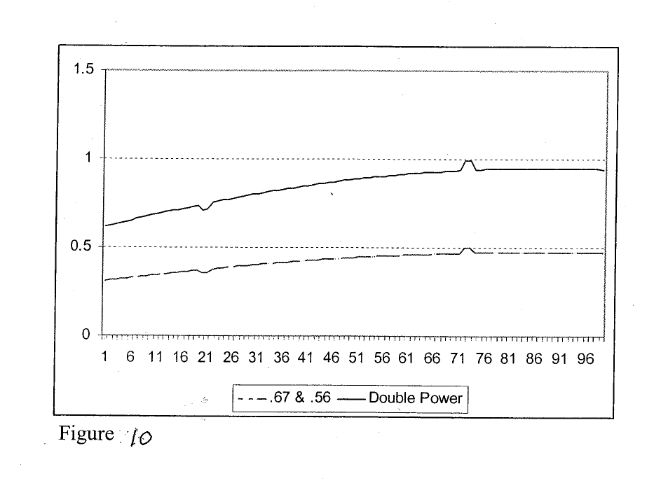

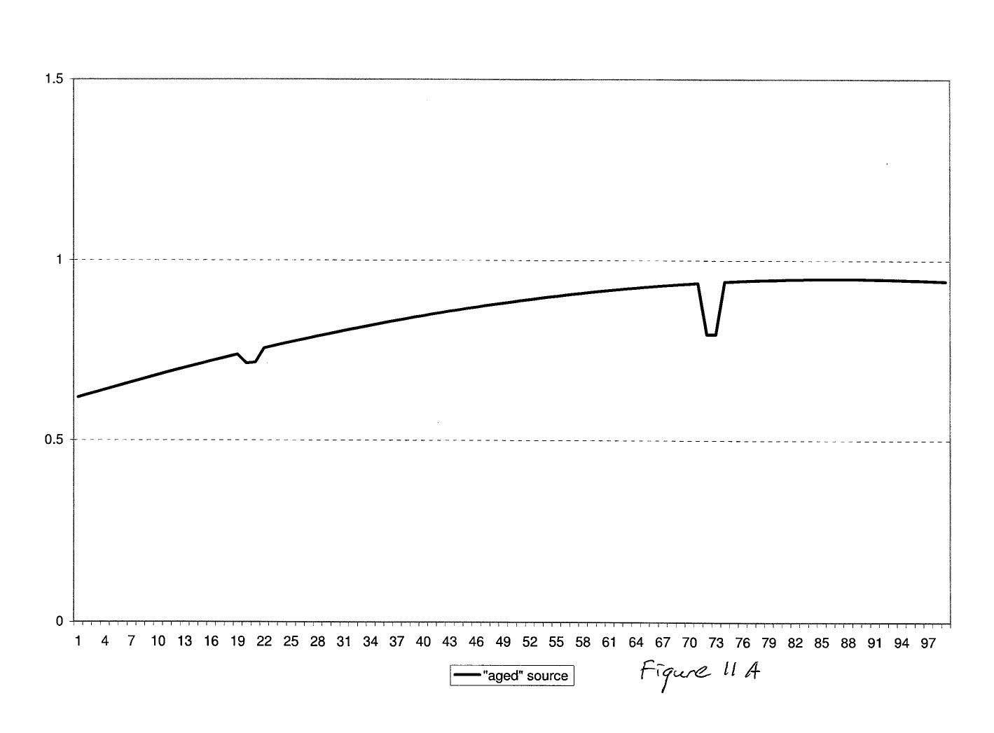

As an illustration, consider the notional spectrum of a “spiky” source, shown in FIG. 9A, where the source is installed in the illuminator of FIG. 1. As has been described previously, in a measurement system for example, this spectrum is dispersed by a grating or prism and detected on a linear array of detectors; in this example there are 96 bands, each detected by a single detector.

As illustrated, the power on the detectors in the region of the spikes centered on bands 21 and 72 is approaching the maximum allowed (indicated by the arbitrary scale value “1”). As a result, detectors away from the spectral spikes are forced to operate below their maximum, reducing the signal to noise ratio below what otherwise could be achieved.

FIGS. 9B and 9C show the notional spectral transmission functions for two filters of the invention that define notch functions (notch filters), that have been designed with a notch at the proper wavelengths in order to control the spikes in the spectrum of FIG. 9A. These filters have an optical filter coating deposited on nominally transparent substrates using an area modulated deposition pattern, such as those illustrated herein. The filters are installed in filter bank 220 and can, accordingly, be translated through the beam of light so the AWT is variable between a minimum and a maximum.

FIGS. 9D-9G, respectively, illustrate several detected spectra. The spectra shown are for the cases where both filters are set at 0% filtering (no change in transmission of the source, FIG. 9A), 100% filtering (the maximum extinction for the particular application, FIG. 9D), 78% filtering (FIG. 9E), 44% filtering (FIG. 9F), and finally where the filter in the region of channel 21 is at 67% filtering and the filter in the region of channel 72 is set at 56% filtering (FIG. 9G).

As shown in the lower graph line of FIG. 10, the ultimate filter setting from FIG. 9G substantially smoothes away the spectral spikes. With the spikes smoothed, the maximum power is only about 50% of the maximum allowed power, so it is possible to double the source operating power as shown by the upper graph line and thus raise the detected spectral power across the entire band to be above the half saturation level (scale value 0.5). Accordingly, the functionality of a source, and of an instrument employing the source, can be enhanced through the invention.

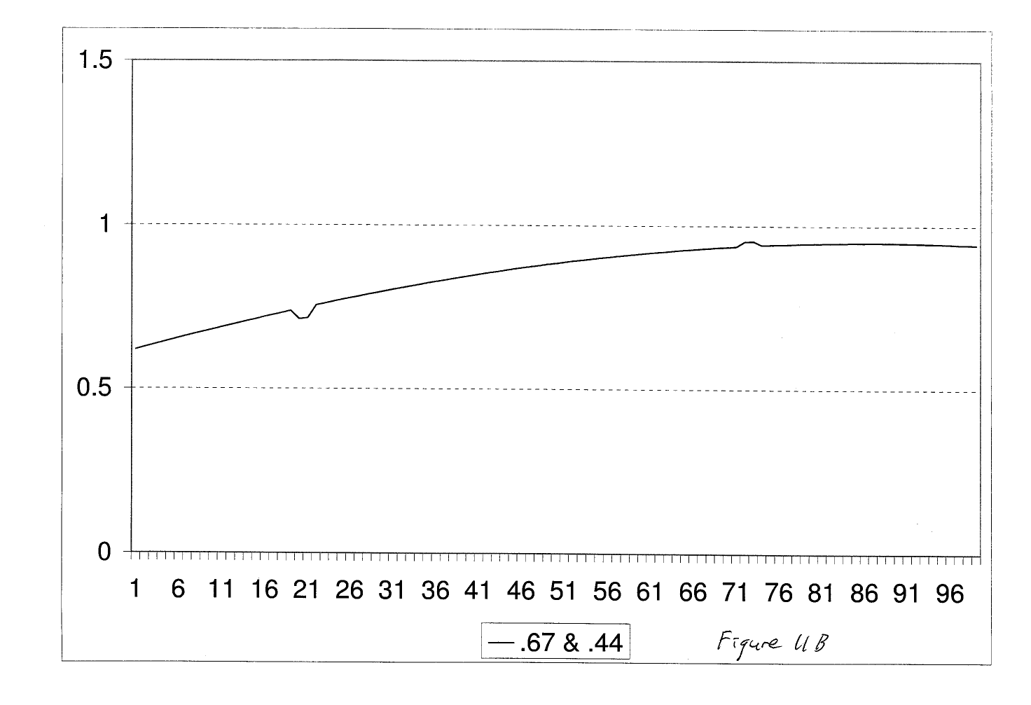

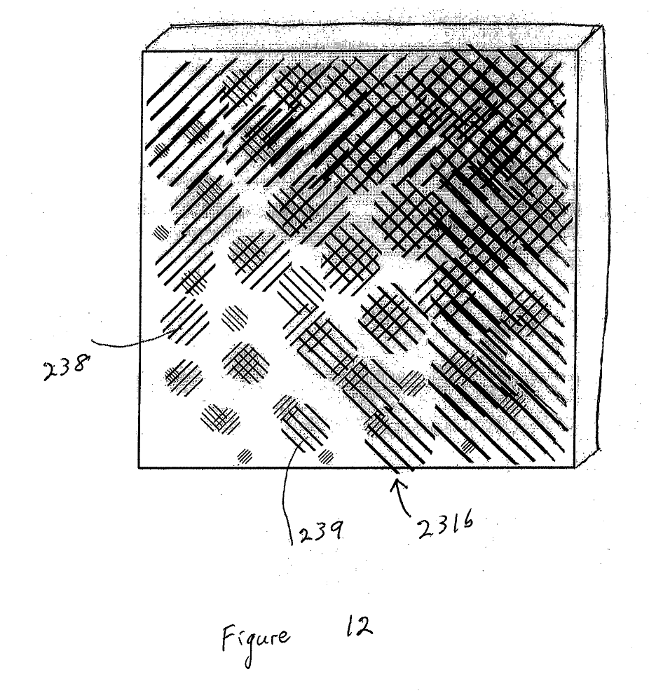

FIGS. 11A and 11B illustrate how the inventive spectrally controlled illuminator compensates for the effects of source aging. As an illustrative example, FIG. 11A shows what might happen as the spectral spike around channel 72 loses power; the figure shows the smoothed, double power spectrum shown in FIG. 10, but with a decreased power output around channel 72. In order to compensate, the operator (or automated feedback system) can reposition the appropriate notch filter, in this example from the original 56% filtering to 44% filtering, with the result shown in FIG. 11B.

In another embodiment, one or more of the optical filters disposed in filter bank 220 are designed to have a filter function that varies in each of the two spatial dimensions that define the planar surfaces of the filters; that is, defining the direction of light propagation as the z-axis, the filter function may vary in both x- and y-directions, viz., f=f(x,y). Said variations may be independent.

As in the previous one dimensional embodiment, each filter is intentionally made larger than the beam size 120; in this embodiment each filter is larger than the beam size 120 in both X and Y dimensions. The extra surface area of each filter allows the user manually (or the system automatically) to position the beam at different relative positions on the filter.

Additionally, as before, each filter is disposed in mechanical connection to filter position adjustment mechanism 510 whereby said filter may be positioned in the beam in both x- and y-directions. For example, for rectangular plate shaped filters, a nested slide mechanism is suitable. Each adjustment mechanism 510 preferably includes a handle 520, adjusting lead screws, or similar elements to facilitate adjusting the filter relative to the beam. Preferably, each adjustment mechanism is provided with scales or position calibration markings to allow the filter to be positioned deterministically, in accordance with a predetermined setting.

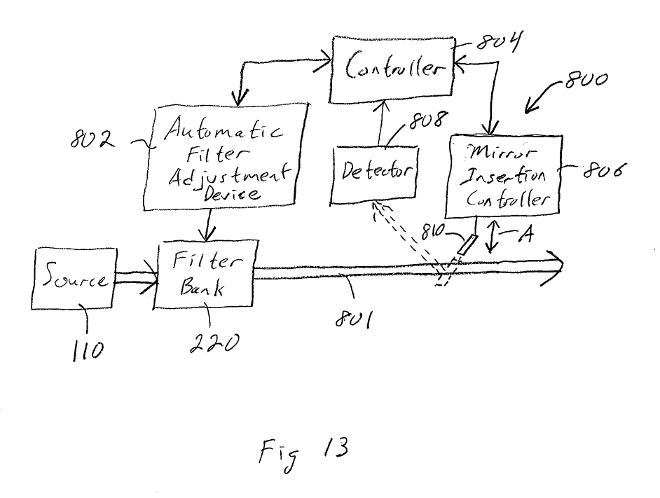

FIG. 12 illustrates an example of a filter 231b with a two-dimensional filter function variation. The filter is the two dimensional analogue of the filter illustrated in FIG. 5C. As illustrated in the figure, the filter comprises two different filter coatings, each of which is deposited as spots of varying size and spatial density, spots 238 representing one coating, and 239 representing the other coating. One coating (spots 238) varies in AWT from top to bottom edge while the other coating, spots 239, varies in AWT from right to left edge. In the locations in which the filter spots overlap, both filter functions apply.

To adjust the source filtration, an operator typically observes the detected spectrum on a display device while translating the filters transversely through the beam. This could also be done automatically with a feedback-based control system such as shown schematically in FIG. 13. Such adjustments could be accomplished by detecting the modified spectrum with a reflector 810 that was temporarily placed into the beam 801 under control of mirror insertion controller 806 that moves mirror 810 into and out of beam 801 in the direction of arrow “A”. Detector 808 would detect the reflected beam and provide the appropriate spectral measurements to controller 804. Controller 804 would cause adjustment of the position of the filters through filter adjustment device 802 until a desired result was achieved. Note that the desired result need not necessarily be a uniform spectrum. Rather, the optimization will depend on the intended target material and overall system response. Accordingly, the aim of the adjustment is to match an a priori defined spectrum. Alternatively, a system with automatic closed-loop spectral control may be used to dynamically adjust system response as parameters such as target reflectivity or scattering spectrum change.

The invention also contemplates a method that involves providing a plurality of optical filters arranged in series in the path of the source, in which the filters together, as a whole, equalize the source spectrum by reducing the relative power of the output at one or more of the spectral band wavelengths, to smooth the power distribution in the band. As described above, the filters are typically transmission filters. The AWT of a filter can be varied by physically moving the filter relative to the source. As an alternative to varying the portion of the beam that the filter coating intersects by moving the filter, the filter may be designed so that the filter coating always intersects the entire beam, but the filter function varies as the filter moves. Typically, the smoothed spectrum is accomplished by detecting the equalized spectrum, and moving one or more of the filters until the detected equalized spectrum accomplishes the desired equalized spectrum. This can be done manually, or automatically, for example, using the feedback-based approach. The controller in such an approach may be programmed with algorithms that establish placements of the filters that achieve predetermined results based on predetermined source inputs.

It will be understood that the particular method, device and system embodying the invention are shown herein by way of illustration and not as a limitation of the invention. The principles and features of this invention may be employed in various and numerous embodiments without departing from the scope of the invention.

What is claimed is:

1. An optical spectrum equalizer for modifying the spectral distribution of an output beam of a source of optical radiation, the optical spectrum equalizer comprising:
one or more optical filters arranged in series in the path of the source, at least one filter defining a spatially-varying Area Weighted Transmission (AWT);
the position of at least one filter relative to the path of the source beam being adjustable;
the filters together, as a whole, modifying the spectrum of the source beam by reducing the relative power in the source beam at one or more of its wavelengths.

2. The optical spectrum equalizer of claim 1 in which filters are transmission filters.

3. The optical spectrum equalizer of claim 1 in which the source beam has one or more power spikes, and the filters reduce the power of one or more of the spikes to be closer to the power at other wavelengths.

4. The optical spectrum equalizer of claim 1 in which the AWT of at least one filter varies from a low in one portion of the filter to a high in another portion of the filter.

5. The optical spectrum equalizer of claim 1 in which a filter has a filter function that defines a notch function.

6. The optical spectrum equalizer of claim 1 further comprising a device for physically moving at least one filter relative to the source beam.

7. The optical spectrum equalizer of claim 6 in which the device comprises an adjustment mechanism.

8. The optical spectrum equalizer of claim 7 further comprising filter position calibration markings associated with the adjustment mechanism.

9. The optical spectrum equalizer of claim 6 in which the device is adapted to move at least two of the filters relative to the source beam.

10. The optical spectrum equalizer of claim 9 in which there are a plurality of filters, each adapted to be moved relative to the source beam.

11. The optical spectrum equalizer of claim 6 in which the device is automatically controlled.

12. The optical spectrum equalizer of claim 1 in which at least one of the filters has an optical filter coating applied to only portions of its face that is exposed to the source.

13. The optical spectrum equalizer of claim 12 in which the filter coating of at least one of the filters essentially covers a first contiguous portion of the face.

14. The optical spectrum equalizer of claim 13 in which the face is essentially uncovered at a different second contiguous portion of the face.

15. The optical spectrum equalizer of claim 14 in which the amount of filter coating coverage varies essentially continuously from the first portion to the second portion.

16. The optical spectrum equalizer of claim 14 in which the first contiguous portion of the face defines a generally linear ramp shape.

17. The optical spectrum equalizer of claim 14 in which the first contiguous portion of the face defines generally triangular areas.

18. The optical spectrum equalizer of claim 14 in which the areal density coverage of the coating varies.

19. The optical spectrum equalizer of claim 14 in which the filter essentially uniformly attenuates each part of the source output in at least one area of the first contiguous portion of the face.

20. The optical spectrum equalizer of claim 12 in which a plurality of the filters have an areal variation of the filter coating, and are physically movable relative to the source beam.

21. The optical spectrum equalizer of claim 12 in which at least a first filter has a generally circular face.

22. The optical spectrum equalizer of claim 21 in which a first contiguous area of the circular face of the first filter is covered with a filter coating.

23. The optical spectrum equalizer of claim 22 in which the first filter is rotatable about an axis that is generally parallel to the source transmission axis and is generally orthogonal to the face of the filter.

24. The optical spectrum equalizer of claim 23 in which the first filter is partially covered with a filter coating such that as the filter is rotated the AWT varies.

25. The optical spectrum equalizer of claim 1 in which a filter is a rugate notch filter.

26. The optical spectrum equalizer of claim 1 in which a filter defines a plurality of notch functions at different wavelengths.

27. An equalized source of optical radiation, comprising:
a source of optical radiation that has a relatively wide wavelength spectral band with an uneven distribution of power at different wavelengths within the band such that the power at one or more wavelengths is greater than the power at some of the other wavelengths, the source emitting a beam of optical radiation;
one or more optical filters arranged in series in the path of the source beam, at least one filter defining a spatially-varying Area Weighted Transmission (AWT);
a device for physically moving at least one filter relative to the source beam;
the filters together, as a whole, modifying the source spectrum by reducing the relative power in the source beam at one or more of its spectral band wavelengths.

28. A method of modifying the output beam of a source of optical radiation, comprising:
providing one or more optical filters arranged in series in the path of the source beam, at least one filter defining a spatially-varying Area Weighted Transmission (AWT);
providing a device for adjusting the position of at least one filter relative to the source beam;
wherein the filters together, as a whole, modify the spectrum of the source beam by reducing the relative power in the source beam at one or more of its wavelengths.

29. The method of claim 28 in which the filters are transmission filters.

30. The method of claim 28 in which the source has one or more power spikes, and the filters reduce the power of one or more of the spikes to be closer to the power at other wavelengths.

31. The method of claim 28 further comprising providing a source of optical radiation that has a relatively wide wavelength spectral band with an uneven distribution of power at different wavelengths within the band such that the power at one or more wavelengths is greater than the power at some of the other wavelengths, to accomplish the provision of a spectrally controlled illuminator.

32. The method of claim 28 in which at least one of the filters has a filter coating applied to only portions of its face that is exposed to the source.

33. The method of claim 28 in which the device is adapted to move each of the filters relative to the source.

34. The method of claim 28 further comprising determining the distribution of power at different wavelength bands of the source, determining the desired equalized spectrum, and arranging the filters such that together they modify the source radiation to the desired equalized spectrum.

35. The method of claim 34 wherein the desired arrangement of filters is accomplished by detecting the equalized spectrum and moving one or more of the filters until the detected equalized spectrum is the desired spectrum.

36. The method of claim 35 in which the filter movement is accomplished automatically.

37. A method of providing an equalized source of optical radiation, comprising:
providing a source of optical radiation that has a relatively wide wavelength spectral band with an uneven distribution of power at different wavelengths within the band such that the power at one or more wavelengths is greater than the power at some of the other wavelengths;
determining the desired equalized spectrum;
determining the distribution of power at different wavelength bands of the source;
providing a plurality of optical filters arranged in series in the path of the source beam, at least one filter defining a spatially-varying Area Weighted Transmission (AWT);
providing a device for physically moving at least one filter relative to the source beam; and
moving one or more of the filters such that together the filters modify the source radiation to the desired spectrum.
